(19) United States
(12) Patent Application Publication
(10) Pub. No.: US 2007/0101766 A1
(43) Pub. Date: May 10, 2007

(54) PROCESS FOR PRODUCING FLAT GLASS, PARTICULARLY FLAT GLASS CONVERTIBLE TO FLOAT GLASS

(76) Inventors: Bernd Loeffelbein, Saulheim (DE); Andreas Langsdorf, Ingelheim (DE); Carsten Schumacher, Horbach (DE); Gerhard Lautenschlaeger, Jena (DE); Dirk Weidmann, Mainz (DE); Hans-Walter Abraham, Darmstadt (DE); Holger Hunnius, Mainz (DE); Mark Bissinger, Wiesbaden (DE); Alfons Moeller, Mainz (DE)

Correspondence Address: STRIKER, STRIKER & STENBY, 103 EAST NECK ROAD, HUNTINGTON, NY, 11743, US

(21) Appl. No.: 11/557,199

(22) Filed: Nov. 7, 2006

(30) Foreign Application Priority Data
Nov. 10, 2005 (DE) 10 2005 053 642.5

(51) Int. Cl. C03C 10/00; C03B 18/02

(52) U.S. Cl. 65/99.2; 65/33.1

(57) ABSTRACT

A process is described for producing flat glass, particularly float glass, that can be converted into glass ceramic, whereby the wetback tile and optionally the restrictor tiles are heated to a temperature above the upper devitrification limit (UDL) of the glass.

### CROSS-REFERENCE TO PRIORITY DOCUMENT

The invention described and claimed hereinbelow is also described in DE 10 2005 053 642.5-45, filed Nov. 10, 2005. This German Patent Application, whose subject matter is incorporated here by reference, provides the basis for a claim of priority of invention under 35 U.S.C. 119 (a)-(d).

### CROSS REFERENCE TO A RELATED APPLICATION

The subject matter of this application is related to co-pending U.S. patent application, Docket No. 3900 to Loeffelbein et al.

### BACKGROUND OF THE INVENTION

The process for producing float glass has been well known for decades. According to the conventional processes, liquid glass is allowed to flow continuously over a spout lip onto the molten metal of the float bath. There the glass spreads out on the float bath until its equilibrium thickness is about 7 mm. If thinner glass is wanted, the glass ribbon is further stretched out on the float bath.

At the spot where the liquid glass meets the float bath, a shoulder is formed. Most of the liquid glass flows forward in the direction of the float bath outlet, but a part of it also flows backward and from there sideways. The part of the float tank in which the glass flows backward is referred to as the wetback region. The wetback region of the float glass is approximately funnel-shaped and opens in the direction of the float tank out-let. The two sides of the funnel usually consist of ceramic tiles known as the restrictor tiles. The narrow part of the funnel is formed by the front wall of the float tank or by a ceramic tile disposed in front of it, referred to as the wetback tile.

The glass flowing backward impinges on the wetback tile and restrictor tiles, is deviated by them and flows with the main part of the glass in the direction of the float tank outlet.

It was discovered previously that the pool of glass appearing in the wetback region can cause defects in the glass. In the glass pool, the residence time of the glass on the float bath is longer than that of the glass that flows directly to the outlet. This can lead to a different viscosity, because the glass cools more, but devitrification and decomposition can also take place.

Hence, it is already known to reduce the viscosity in this region by heating the marginal strips of the glass ribbon in the wetback region by means of an electric current (German patent DE 1 596 590 or U.S. Pat. No. 3,850,787). A drawback of this method is that the edge of the glass is subjected to an electrolytic effect. It is also known from DE 1 596 627 A, particularly as regards the production of thick glasses to build a heating element into the wet-back region underneath the spout lip but above the glass level in the vicinity of the wet-back tile. The heating power input that is to compensate for the heat loss, however, must be very accurately controlled so that it is even necessary to provide special observation windows in the sidewalls of the float tank. Moreover, this type of heating affects the actual critical spot, namely the region of refractory material/glass contact or refractory material/glass/tin contact only very indirectly and insufficiently.

Moreover, in DE-C 1 596 636 and the equivalent U.S. Pat. No. 3,492,107 are described boundary walls (restrictor and wetback tiles) made of electrically conductive refractory material and which at their top, above the part that is immersed in the bath metal, are connected to an electrode, while the bath metal forms the second electrode so that when they are connected to an electric power source a current flows through the refractory material heating it. Here, too, the heating will impart a lower viscosity to the glass layer in the immediate vicinity of the refractory material. The drawback of this type of heating is that it can give rise to stray currents having a negative effect on the flow of the bath metal and that at the contact spots the glass can be altered electrolytically. Both are undesirable if high-quality glass is to be produced.

Another method is known from DE-A-2 218 275 according to which the flow velocity of the liquid glass can be improved by special shaping of the entire guiding arrangement.

Carrying out the indicated processes with crystallizable glass varieties usually gives rise to products that do not meet the increased requirements. In fact, in the temperature range in which, for the purpose of stretching the glass ribbon, it is necessary to work with relatively low cooling rates, a crystallization also takes place so that the subsequent ceramization of the glass, namely the conversion of the glass into a glass ceramic in which the glass, for the purpose of nucleation, must be kept for an exactly determined time at an exactly defined temperature and is then, at a higher temperature, allowed to grow crystals from the nuclei formed, is negatively affected during the stretching of the glass ribbon by the undesirably formed crystals.

The wetback tile and the restrictor tiles can act as heterogeneous nuclei which because of the long residence time in the wetback region can lead to disturbing crystal formation at the edge. During the subsequent ceramization, this, in turn, leads to irregularities, particularly to marked strains in the glass ribbon which can cause the glass to break in the annealing oven.

This problem has thus far been attacked in two ways. On the one hand, glass varieties have been developed which are less susceptible to form such trouble spots and, on the other, the unwanted crystallization or nucleation is counteracted by a purposeful formation of a stream in the bath metal.

According to U.S. Pat. No. 3,684,475, by means of a recycle pump, a laminar flow of the bath metal is created which equals in speed the glass ribbon on the metal bath as a result of which an uneven speed of the bath metal in the edge region and an uneven crystallization associated therewith, particularly in the edge region, should be prevented. According to WO 2005/0 731 38 A1, too, a stream of bath metal is introduced into the wetback region which is intended to prevent the backward spreading of the “onion” so far that the glass can no longer form a fixed point on the wetback tile. In the absence of a fixed point, however, it is difficult to hold the position of the glass ribbon stable so that a defined shaping of the glass ribbon is made difficult.

### SUMMARY OF THE INVENTION

The object of the invention is to provide a float process which is easy to carry out and which even in the floating of glasses prone to crystallization (namely green glasses for the production of glass ceramic plates) prevents the undesirable devitrifications in the edge regions to an extent such that neither do increased strains appear in the glass ribbon nor is the glass broken in the annealing oven. In this process, particularly to ensure the shaping of the glass ribbon, the proven wetback and restrictor tiles can find continued use in the wetback region so as to ensure the constant position of the glass ribbon in the wet-back region.

It was found that the indirect heating of the boundary walls coming in contact with the liquid glass to a temperature that is higher than the upper devitrification limit (UDL) of the glass involved prevents to a large extent the formation of crystal nuclei or of crystals, or this formation is so slight that in the course of the subsequent phases of the float process it no longer causes any disturbing effects.

Depending on the conditions under which the float process is carried out, in the wetback region the glass comes in contact only with the front wall or with a shaped element, namely the wetback tile, disposed in front of the front wall. Much more frequent, however, are processes in which in addition to the wetback tile two shaped elements (restrictor tiles) extending in the flow direction of the melt are present to guide the glass melt in the wetback region and, as seen in the direction of glass flow, a slight distance beyond it. All boundary surfaces coming in contact with the liquid glass must be heated to a temperature above the UDL so that crystal formation (nucleation) cannot occur on them. By boundary surfaces are meant all surfaces, shaped elements and the like that come in contact with the glass melt. The surfaces need not consist of ceramic, but may be fabricated from a suitable metal, or shaped ceramic elements with a metal cladding may be used, for example with sheet metal cladding or a galvanically applied metal coating. As a rule, however, because of cost-related reasons, shaped elements made of fire-resistant ceramic material are used.

The indirect heating of the boundary surfaces is carried out by resistance heating with an electric current.

Indirect heating of the boundary surfaces involves bringing the boundary wall or the shaped element in heat-conducting connection with an electric heating resistor.

In the case of the preferably used shaped elements made of ceramic, the shaped element is provided with a, preferably internally disposed, heating resistor. Suitable heating resistors are all metals and compounds capable of resisting the required temperatures, for example metallic conductors made of tungsten, molybdenum, platinum, iridium, liquid tin, alloys of the platinum metals as well as carbon, silicon carbide or molten glass. To prevent leakage currents or stray currents, the heating resistor is preferably electrically insulated from the shaped element by a coating or jacket (if said element is electrically conductive) or if the shaped element itself constitutes an electric insulator.

The use of shaped elements (wetback and resistor tiles) made of electrically insulating material is preferred, a suitable material consisting, for example, of sintered quartz (fused silica). To reliably prevent the unwanted formation of crystals or crystal nuclei and trouble spots which during the subsequent phases of the float process could cause uncontrolled crystallization particularly in the marginal regions of the glass ribbon, the surfaces or tiles in the wetback region coming in contact with the liquid glass are heated to a temperature above the UDL, namely the upper devitrification limit of the glass in question. At this temperature, no crystal nuclei or crystals can form on contact with the surface. The UDL is the lowest temperature in the range of the processing temperature of the glass at which no crystals are formed in the glass when the glass is allowed to stand for five hours. The UDL of the floating glass can be determined by the following method: The glass is melted in platinum crucibles. The crucibles are then kept for five hours at different temperatures in the range of the processing temperature and are then rapidly cooled. The lowest temperature at which still no crystals appear is the UDL. The UDL depends on the variety of glass in question. It can generally be said that the UDL is, in general, in the range above about 950° C. Reasonably, however, because of the energy cost involved, heated wetback and restrictor tiles are used only for glasses with a UDL of at least 1000° C.

In practical operation it may be advantageous to keep the contact surfaces at a temperature slightly above the determined UDL to compensate for any thermal irregularities at the contact surfaces. A temperature of 10 to 30° C. above the UDL was found satisfactory. At any rate, the UDL should not be exceeded just by any amount, because this could lead to an increased energy consumption, increased wear of the heating elements and boundary tiles and excessive vaporization of the glass at the contact surfaces without being compensated for by an improved performance. A temperature of more than 100° C. above the UDL should therefore not be exceeded for economic reasons.

### BRIEF DESCRIPTION OF THE DRAWINGS

The invention will be explained in greater detail by way of the drawings in which:

FIG. 1 shows a longitudinal section through the wetback region of a float unit according to the invention;

FIG. 2 shows a top view of the wetback region of a float tank with wetback and restrictor tiles;

FIG. 3 is a magnified view of a restrictor tile; and

FIG. 4 shows a section through the restrictor tile of FIG. 3.

### DETAILED DESCRIPTION OF THE PREFERRED EMBODIMENTS

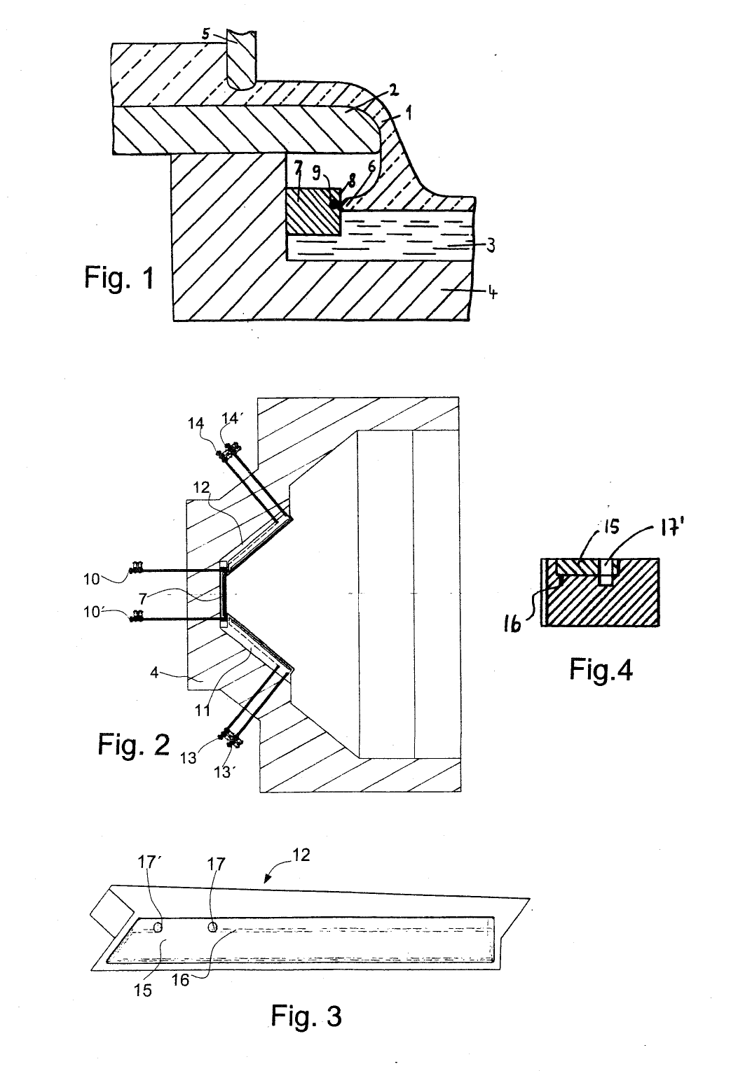

FIG. 1 shows schematically the inlet zone (wetback region) of a float glass unit. The liquid glass 1 flows over a spout lip 2 onto the metal 3 which is kept in a tank 54. The quantity of glass reaching the bath 3 is adjusted with a slider (front wheel) 5. As can be seen, the glass flowing onto the bath forms a heel 6 which abuts against a wall 8 formed by a ceramic tile 7. Wall 8 is heated to a temperature above the UDL with a heating element 9 so that at this wall no crystals or crystal nuclei are formed.

FIG. 2 shows a top view of the wetback region in which for better comprehension the spout lip has been omitted. The figure shows wetback tile 7 with two power supply lines 10 and 10′ for the heating element. The power supply lines consist of copper and are cooled. Restrictor tiles 11 and 12 adjoin wetback tile 7 on both sides in a funnel-shaped arrangement with the funnel opening in the direction of glass flow. Said tiles still come in contact with the molten glass and the heating elements thereof are supplied with energy by way of power supply lines 13, 13′ and 14, 14′. FIG. 3 shows a top view of restrictor tile 12 and FIG. 4 a section through restrictor tile 12. The body of restrictor tile 12 is provided on its top side with a quadrangular recess which is closed with a lid 15. Underneath lid 15 is provided a groove 16 within which is disposed the electric heating resistor. Lid 15 is provided with openings 17 and 17′ through which the heating resistor can be brought in contact with the power supply lines 14 and 14′. In this case, the heating resistor consists of tin which is liquid during the operation. The material used for the restrictor tile is in this case sintered silica.

In some cases, it is sufficient to insulate power supply lines 10, 10′, 13. 13′, 14, 14′ only thermally so that cooling can be omitted. It is also possible to use heat-resistant sup-ply lines made of W, Pt, Ir, C or a platinum alloy which optionally can merge directly with the internal heating resistor of the same kind. A combination of water-cooled supply lines (for example Cu) with uncooled electrodes (for example W) which are in electric contact with the internal heating resistor (for example Sn or SiC) provides an alternative.

By this process are produced glass ribbons having the dimensions that are common in float glass production, namely widths of up to 6 m and over and thicknesses between 0.3 mm and 25 mm and preferably between 0.3 mm and 6 mm.

The wetback tile used can be, for example, a bar having the dimensions 1000×80×80 mm (l×w×h) and consisting of sintered silica and which is provided with a tin heating resistor having the dimensions 960×5×20 mm (l×w×h). The heating resistor in the bar is covered, the design corresponding in principle to the embodiment shown in FIGS. 3 and 4. The bar was subjected to a heating current of about 2000 A and produced 12 kW of heating power. As a result, the temperature in the wall of the bar in the glass contact region was about 1300° C.

It will be understood that each of the elements described above, or two or more together, may also find a useful application in other types of constructions differing from the types described above.

While the invention has been illustrated and described as embodied as a process for producing flat glass, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

What is claimed is:

1. A process for producing flat glass, comprising the steps:
in a float glass unit, continuously pouring liquid glass in a glass stream onto a metal bath in a pouring zone, where the liquid glass is shaped to a ribbon of desired width and thickness, whereby the glass stream in the region of the pouring zone abuts against at least one heated boundary wall, wherein the liquid glass poured is a precursor glass for a glass ceramic, wherein at least one boundary wall is heated to a temperature above the upper devitrification limit (UDL) of the glass, and wherein at least one boundary wall is heated indirectly.

2. The process as defined in claim 1, wherein a ceramic tile is used as at least one boundary wall.

3. The process as defined in claim 2, wherein an electrically insulating ceramic tile is used.

4. The process as defined in claim 1, wherein three boundary walls are used.

5. The process as defined in claim 1, wherein the at least one boundary wall is heated to a temperature between UDL and UDL+100° C.

6. The process as defined in claim 1, wherein the at least one boundary wall is heated electrically.

7. The process as defined in claim 1, wherein the at least one boundary wall is heated by a heating resistor that is introduced into it.

8. The process as defined in claim 7, wherein the heating resistor is disposed in a covered channel.
